(19) United States
(12) Patent Application Publication
(10) Pub. No.: US 2025/0206171 A1
(43) Pub. Date: Jun. 26, 2025

(54) CENTRAL ELECTRICAL DEVICE FOR OPERATING AN ELECTRIC DRIVING AND/OR RECUPERATION AXLE OF A TRAILER OR SEMITRAILER OF A UTILITY VEHICLE

(71) Applicant: ZF CV Systems Global GmbH, Bern (CH)

(72) Inventors: Nils Pfullmann, Hannover (DE); Steffen Gerlach, Hannover (DE); Alexander Rodenberg, Braunschweig (DE); Fabian Ickerott, Muenster Albachten (DE); Michael Schomburg, Barsinghausen (DE)

(21) Appl. No.: 19/076,463

(22) Filed: Mar. 11, 2025

Related U.S. Application Data
(63) Continuation of application No. PCT/EP2023/072567, filed on Aug. 16, 2023.

(30) Foreign Application Priority Data
Sep. 15, 2022 (DE) 10 2022 123 622.6

(51) Int. Cl. B60L 53/57; B60K 1/00; B60L 15/20; B60L 50/60; B60R 16/023; B62D 59/04; G07C 5/02

(52) U.S. Cl. CPC B60L 53/57; B60K 1/00; B60L 15/20; B60L 50/60; B60R 16/0238; B62D 59/04; G07C 5/02; B60K 2001/006; B60L 2200/28

(57) ABSTRACT

A central electrical device is for operating an electric driving and/or recuperation axle of a trailer or semitrailer of a utility vehicle. The central electrical device includes at least two electrical and/or electronic components which are arranged in a common housing and are interconnected inside the housing in such a way that the components, which operate at the same voltage level, are guided to a common interface, formed on the housing, for connection to the electric driving and/or recuperation axle of the trailer or semitrailer of the utility vehicle.

### CROSS-REFERENCE TO RELATED APPLICATIONS

This application is a continuation application of international patent application PCT/EP2023/072567, filed Aug. 16, 2023, designating the United States and claiming priority from German application 10 2022 123 622.6, filed Sep. 15, 2022, and the entire content of both applications is incorporated herein by reference.

### TECHNICAL FIELD

The disclosure relates to a central electrical device for operating an electric driving and/or recuperation axle of a trailer or semitrailer of a utility vehicle. The electric driving and/or recuperation axle is preferably configured as an e-drive axle. The trailer or semitrailer can be configured as a tipper, central-axle trailer or semitrailer.

### BACKGROUND

It is known that e-drive axles are employed in trailers or semitrailers of utility vehicles and are distinguished by the fact that an electric drive machine is integrated into the axle. Such a trailer or semitrailer can be attached to any truck or any tractor and makes it into a hybrid vehicle. The additional self-driving of the trailer or semitrailer influences the traction and the acceleration of the overall vehicle.

All the known electric trailer systems use various component arrangements which contain the electrical and/or electronic components necessary for voltage supply and for driving. These component arrangements are distributed throughout the entire trailer or semitrailer and make installation at just one trailer or semitrailer fabrication site or on a regular production line more difficult.

### SUMMARY

It is an object of the disclosure to overcome the disadvantages of the prior art, in particular to specify a central electrical device which can be assembled at just one site or on a regular production line.

This object is achieved via a central electrical device according to the disclosure. According to this, the central electrical device for operating an electric driving and/or recuperation axle of a trailer or semitrailer of a utility vehicle includes at least two electrical and/or electronic components, which are arranged in a common housing and are interconnected inside the housing in such a way that the components which operate at the same voltage level are routed to a common interface, formed on the housing, for connection to the electric driving and/or recuperation axle of the trailer or semitrailer of the utility vehicle. Such a central electrical device has a reduced number of interfaces connecting the central electrical device to the trailer or semitrailer, and it can be supplied in preassembled form to the manufacturer of the trailer or semitrailer. At the trailer or semitrailer manufacturer's, it is possible for assembly purposes to dispense with subsequent skilled finishing work since only the small number of interfaces with the trailer or semitrailer have to be connected. It is thereby possible to shorten the assembly time and save on assembly steps. It is also possible to a large extent to dispense with the use of trained production personnel and highly specialized workers with knowledge, for example, of high-voltage components and circuits. It is not necessary to make configuration changes to the trailer or semitrailer. The central electrical device can be produced in large numbers.

The trailer or semitrailer manufacturer has only to replace a conventional axle with an e-drive axle. The e-drive axle is an electric-motor-driven axle, wherein the electric motor is positioned on the axle. It is thus possible to produce an electric trailer functionality which includes the recovery of kinetic energy from mechanical energy, this being referred to as recuperation, and the provision of a motive force from electrical energy to assist the tractor in overcoming driving resistance, this being referred to as traction.

In the simplest variant, the interconnection, within the housing, of the components operating at the same voltage level is accomplished via a distribution unit corresponding to the voltage level, wherein the distribution unit can have, in particular, a protection unit. Such a distribution unit connected to a voltage source supplies the individual electrical components with the corresponding voltages. If the distribution unit is supplemented by a protection unit which includes fuses and/or relays, the lines to the electrical and/or electronic components are protected separately from one another if overloading of the line occurs. Inability of the central electrical unit to function is thereby largely prevented.

The electrical components operating at a high voltage level are connected via a high-voltage distribution unit or via a high-voltage distribution and protection unit to a high-voltage source positioned in the housing and are routed to a common high-voltage interface for operating a drive component of the driving and/or recuperation axle. Via the high-voltage distribution and protection unit, all the electrical components within the central electrical device are supplied with energy by just one high-voltage source. At the same time, the high-voltage source supplies the electric driving and recuperation axle with energy via a single high-voltage interface.

In an embodiment, the electrical and/or electronic components are routed via a low-voltage module, which preferably has a low-voltage distribution and/or protection unit, to a common low-voltage interface for supplying voltage and/or controlling at least one low-voltage component positioned in the driving and/or recuperation axle. In this case, too, the low-voltage lines are interconnected within the central electrical device, and the low-voltage lines are brought together in the low-voltage module, which likewise has fuses and relays to protect the individual low-voltage lines. The low-voltage module leads to only one low-voltage interface, which is configured to transfer the data and/or voltages transmitted on the low-voltage lines to a control device of the driving and/or recuperation axle, which can be positioned on the driving and/or recuperation axle. The low-voltage interface is advantageously configured as a cable harness.

The low-voltage module can be connected directly to a low-voltage source, which is arranged within the housing of the central electrical device. Thus, both the low-voltage components arranged within the housing and the control device placed externally on the driving and/or recuperation axle are supplied with energy at a low-voltage level.

In a particularly simple embodiment, the high-voltage interface, which is connected to the high-voltage source via an inverter, is configured as an alternating current interface for direct voltage supply to an electric motor driving the driving and/or recuperation axle. For this purpose, just one high-voltage interface is needed on the housing, which is preferably configured as a plug with a large cross section. However, this high-voltage interface is used not only to transfer electrical energy to the driving and/or recuperation axle in order to drive the electric motor. In the opposite direction, during the recuperation mode of the driving and/or recuperation axle, in which the electric motor operates as a generator and is driven by the mechanical energy of the wheels, the mechanical energy can be used to generate electrical energy, which is fed back via this high-voltage interface to the central electrical device in order to charge the high-voltage battery.

In another embodiment, the high-voltage source of the high-voltage interface configured as a direct current interface is configured to supply voltage to an inverter positioned on the driving and/or recuperation axle, and the low-voltage interface is configured to supply and control a control device of the electric motor, the control device being mounted on the driving and/or recuperation axle. This thus represents the simplest variant of the central electrical device, which requires just one high-voltage interface and one low-voltage interface for coupling to the trailer or semitrailer.

In an embodiment, a cooling system for the electric driving and/or recuperation axle is arranged in the housing, wherein the cooling system is routed via a cooling line located within the housing to a coolant interface, formed on the housing, for cooling the electric driving and/or recuperation axle. The cooling interface is preferably configured as a coupling, which connects the cooling line located within the housing to a cooling line of the driving and/or recuperation axle. The coupling can be installed with just a few hand movements. As a result, the coupling process between the central electrical device and the driving and/or recuperation axle is significantly simplified. Within the housing, it is possible to cool not only the high-voltage battery but also other electrical components by connecting the corresponding cooling lines from the cooling system to these further components.

In another embodiment, a control device, outside the housing, for the trailer or semitrailer, which is connected via an electronic gateway to a data and/or energy line of the utility vehicle, is routed from the outside, via a control device interface of the housing, to the low-voltage module and, via the low-voltage interface of the housing, outputs control signals to the control device of the electric driving and/or recuperation axle. With this convenient configuration, it is thus also possible to connect external control devices specific to the utility vehicle to the central electrical device. This has the advantage that the driving conditions of the tractor and trailer or semitrailer can be matched to one another.

In another embodiment, the control device outside the housing is configured as a brake control device for the trailer or semitrailer. In this way, it is possible, for example, to transmit a deceleration or acceleration request of the tractor and the inclination thereof to the brake control device via the standardized interface. From this, the brake control device can draw conclusions about the driving dynamics and provide data which are sent via the low-voltage interface to the control device of the driving and/or recuperation axle, ensuring that the electric motor is controlled in such a way that the driving dynamics of the overall utility vehicle are improved.

In another embodiment, the control device is connected to a telematics unit of the utility vehicle for improving the driving dynamics and/or the efficiency and/or the vehicle monitoring of the utility vehicle. Alternatively, the telematics unit can also be attached directly to the low-voltage interface. For this purpose, an additional data line is attached to the connection between the low-voltage interface and the control device. The telematics unit is used to determine data pertaining to the distance of the utility vehicle from the destination. From these, it is possible to draw conclusions as to whether the state of charge of the high-voltage battery is sufficient to reach the destination. From the surface profiles of the surroundings of the route to be driven, it is possible to determine when it is advantageous to put the driving and/or recuperation axle into the recuperation mode in order to charge the high-voltage battery while the utility vehicle is being driven and thus to even out the energy balance.

In another embodiment, an electrical power interface, which can be routed via a further electrical power interface of the housing to an auxiliary unit of the trailer or semitrailer, is arranged in the housing. The first-mentioned electrical power interface is very versatile. Thus, it can equally well be used to operate a cooling compressor for cooling the cargo in the trailer or semitrailer. It is also conceivable for a forklift truck attached to the trailer or semitrailer to be supplied with energy via this power interface. Since the power interface can also be configured as a separate stand-alone system, there is no need for a separate high-voltage battery to supply the auxiliary unit of the trailer or semitrailer.

In another embodiment, the auxiliary unit of the trailer or semitrailer is configured as a cooling unit. The elimination of a diesel compressor in the cooling unit improves the noise level of the trailer or semitrailer. At the same time, there is a space saving in the trailer or semitrailer. The energy required to supply the cooling unit can also be balanced out by the recuperation mode of the driving and/or recuperation axle.

In another embodiment, a battery charger, which is connected to a further high-voltage interface of the housing for external energy transfer into and/or from the high-voltage battery, is arranged in the housing. If the energy consumption in the central electrical device is too high or the charge status of the high-voltage battery is too low, the high-voltage battery can be charged externally at any time.

In another embodiment, a mechanical interface for fastening to a chassis of the trailer or semitrailer of the utility vehicle is formed on the housing. The central electrical device pre-produced in this way can be easily mounted on the trailer or semitrailer via this mechanical interface by the manufacturer of the trailer or semitrailer. Depending on the type of trailer or semitrailer, the central electrical device can be secured on a lateral surface or a floor or on or to a roof surface of the trailer or semitrailer. In the case of semitrailers, it is expedient to position the central electrical device in the region of the pallet box provided for pallets. In the case of tipper trucks, arrangement of the central electrical device on the ladder frame thereof is recommended.

### BRIEF DESCRIPTION OF DRAWINGS

The invention will now be described with reference to the drawings wherein:

FIG. 1A and FIG. 1B show a schematic illustration of an embodiment of the central electrical device according to the disclosure on a semitrailer of a utility vehicle;

FIG. 2 shows a schematic illustration of a first embodiment of an electrical interconnection of the central electrical device according to the disclosure of the electric driving and/or recuperation axle; and,

FIG. 3 shows a schematic illustration of a second embodiment of an electrical interconnection of the central electrical device according to the disclosure of the electric driving and/or recuperation axle.

### DETAILED DESCRIPTION

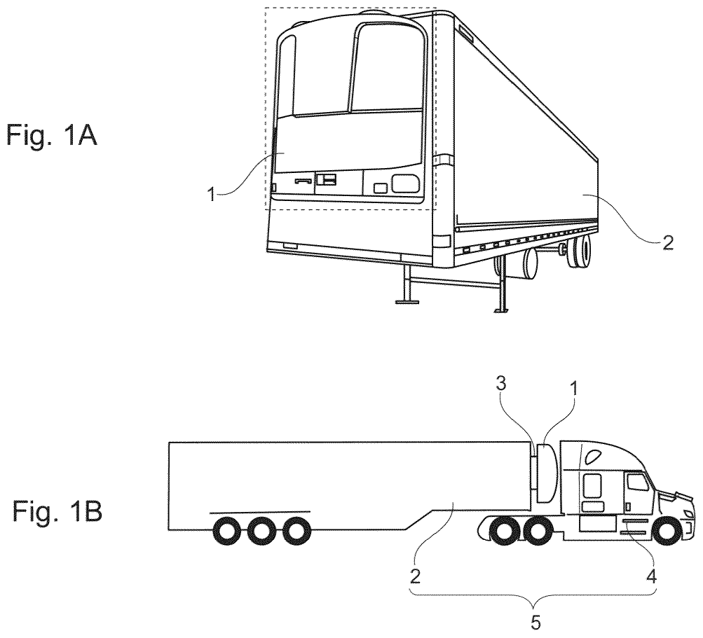

An embodiment of the arrangement of the central electrical device according to the disclosure on a semitrailer is illustrated in FIG. 1A. The central electrical device 1, which is configured as a box, is secured on a narrow side of a semitrailer 2 via a mechanical interface 3 (FIG. 1B). After the attachment of the central electrical device 1, the manufacturer of the semitrailer 2 brings it to the manufacturer of the tractor 4, on which the semitrailer 2 is mounted and thus, together with the tractor 4, forms the utility vehicle 5.

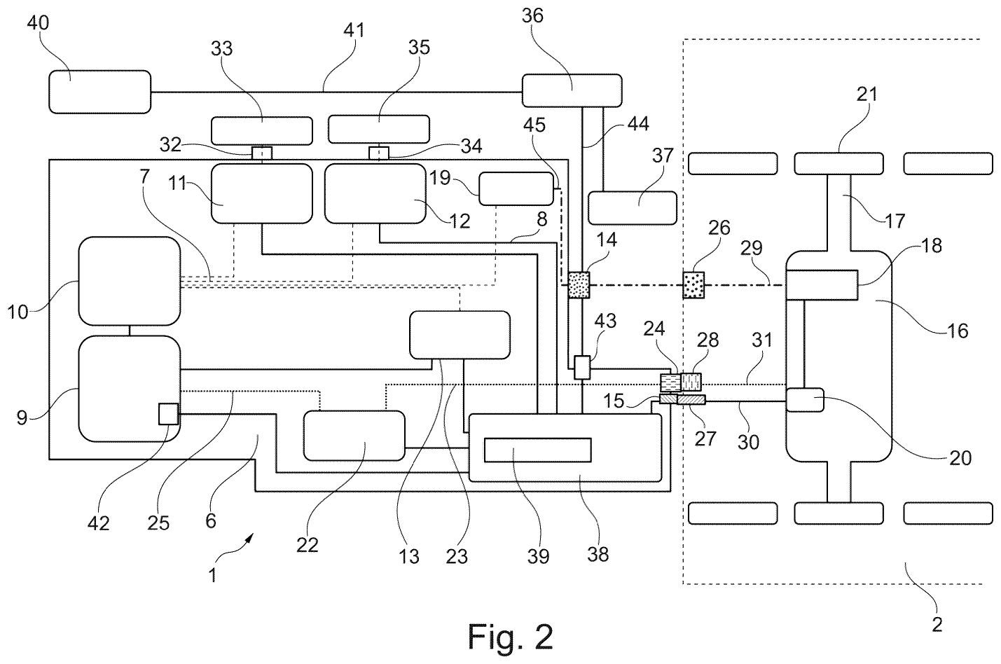

FIG. 2 shows a schematic illustration of a first embodiment of an electrical interconnection of the central electrical device 1 according to the disclosure with the electric driving and/or recuperation axle 16. The central electrical device 1 includes a housing 6, in which a high-voltage network 7 and a low-voltage network 8 are formed. Various high-voltage components arranged in the housing 6 are supplied with voltage via a high-voltage distribution and protection unit 10 by a high-voltage battery 9, which supplies a voltage of 650 to 800 volts. These components include an inverter 19, an electrical power interface 11 for supplying auxiliary units of the semitrailer 2, and a battery charger 12, which are simultaneously connected to a low-voltage module 38 via the low-voltage network 8 for the purpose of data transfer. A low-voltage distribution and protection unit 39 is integrated into this low-voltage module 38. Via the high-voltage distribution and protection unit 10, the high-voltage battery 9 is connected to a DC/DC converter 13, which converts the direct voltage supplied by the high-voltage battery 9 for supplying the low-voltage module 38 with voltage into a low-voltage direct voltage. The high-voltage battery 9 is thereby connected to the low-voltage power network, and low voltages are supplied for the low-voltage module 38 and a battery management system 42 connected to the low-voltage module 38.

From the high direct voltage, the inverter 19 supplied by the high-voltage battery 9 produces high alternating voltage, which is routed via a high-voltage line 45 directly to the single high-voltage interface 14 formed as an alternating-current interface on the housing 6, while the low-voltage module 38 is routed to a low-voltage interface 15, which is likewise formed on the housing 6. The high-voltage interface 14 is formed by a plug with a large cross section, while the low-voltage interface 15 is configured as a cable harness.

The high-voltage interface 14 and the low-voltage interface 15 each form an interface with the electric driving and/or recuperation axle 16 (e-drive axle) of the semitrailer 2 in order to supply the latter with voltage and to exchange data or control signals therewith. For the purpose of driving the mechanical axle 17, an electric motor 18 supplied with alternating voltage is positioned thereon, the electric motor being controlled by a control device 20, likewise secured on the axle 17, via the signals provided by the low-voltage module 38. In the traction mode, the electric driving and/or recuperation axle 16 operates as a driving axle for driving the wheels 21 of the semitrailer 2, which are secured on the mechanical axle 17. However, the electric driving and/or recuperation axle 16 can also be operated in a recuperation mode, in which electrical energy is obtained from the mechanical energy applied by the wheels via the electric motor 18, which operates as a generator, the energy being fed into the high-voltage network 7 via the high-voltage interface 14, where it can be used to recharge the high-voltage battery 9 or to supply the electrical power interface 11 with energy. A recuperation mode is set when the utility vehicle 5 drives downhill.

In addition to the electrical components described, the housing 6 contains a cooling system 22 for the electric driving and/or recuperation axle 16. This cooling system 22 is connected to a cooling line 23 within the housing, which leads to a cooling interface 24, for example, in the form of a coupling, formed on the housing 6. The cooling system 22 is connected via a second cooling line 25 within the housing to the high-voltage battery 9 and to further internal components in order to cool them. In addition, the cooling system 22 is controlled by the low-voltage module 38, which controls the cooling system 22 in accordance with signals from the control device 20 secured on the mechanical axle 17.

When the central electrical device 1 is coupled mechanically to the semitrailer 2, corresponding mating parts 26, 27, 28 fit into the high-voltage interface 14, the low-voltage interface 15 and the cooling interface 24, the mating parts being formed on the chassis of the semitrailer 2. Corresponding connections 29, 30, 31 run from the chassis to the electric driving and/or recuperation axle 16, this being shown in simplified form in FIG. 2 for the sake of clarity. These lines 29, 30, 31 can advantageously be laid in the frame of the semitrailer 2.

The power interface 11, which is configured as an electrical cooler interface, and the battery charger 12 as well as the cooling system 22 can be optional components which are not necessarily included in the basic equipment of the central electrical device 1. Via an additional interface 32, the cooler interface 11 is connected to a cooling unit 33 of the semitrailer 2. The battery charger 12 can be connected via a further interface 34 to an external local network 35 for charging the high-voltage battery 9.

The semitrailer 2 has a dedicated brake control device 36, which is connected via a line 41 having a standardized plug 40, for example, ISO 7638, to the ABS and ESP system of the tractor 4. Via this, the brake control device 36 of the semitrailer 2 obtains all the information on the driving and braking behavior of the tractor 4. The external coupling of the brake control device 36 to the low-voltage module 38, which is accomplished via a control device interface 43 of the housing 6, enables data and energy exchange in both directions, via line 44, between the brake control device 36 and the control device 20 of the electric driving and/or recuperation axle 16 via the existing low-voltage interface 15. Since, in addition to the abovementioned information, the brake control device 36 also identifies the intentions of the driver of the tractor 4, the driving dynamics and efficiency of the overall utility vehicle 5 are improved. At the same time, a recuperation mode of the electric driving and/or recuperation axle 16 and the effects thereof on the driving dynamics of the overall utility vehicle 5 are taken into account.

In order to improve the driving dynamics even further, a telematics unit 37 of the utility vehicle 5 is connected to the brake control device 36, the unit likewise communicating via the low-voltage interface 15 with the control device 20 of the driving and recuperation axle 16. This ensures predictive consideration of route optimizations and terrain characteristics, such as roads with a large number of bends, large differences in altitude and also relatively large diversions from the originally specified route, when matching the driving dynamics of the tractor 4 and the semitrailer 2 to one another. This ensures that the electric driving and recuperation axle 16 always adopts an operating mode such that the tractor is always assisted by the semitrailer 2 when driving. This is of particular significance especially for autonomous driving of the utility vehicle 5.

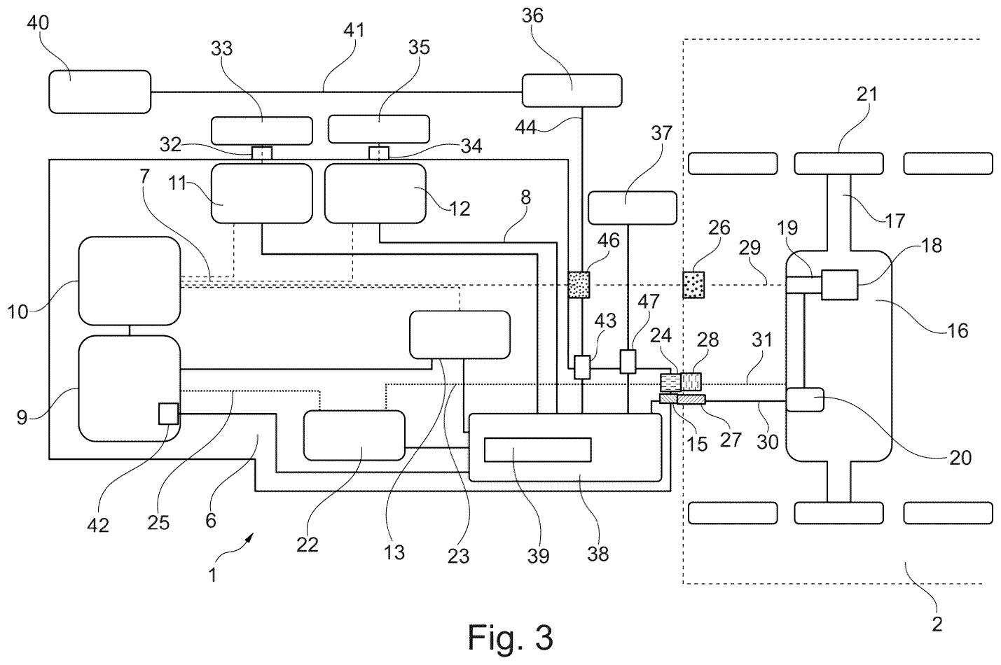

A second embodiment of an electrical interconnection of the central electrical device according to the disclosure of the electric driving and/or recuperation axle is illustrated in FIG. 3. In contrast to FIG. 2, the high-voltage battery 10 is connected directly to a high-voltage direct current interface 46 of the housing 6, which leads via the line 29 to the inverter 19, which is arranged in the driving and recuperation axle 16 and supplies the electric motor 18 with alternating voltage. The control device 20 of the driving and recuperation axle 16 is coupled to the inverter 19. The telematics unit 37 is decoupled from the brake control device 36 and leads directly, via a telematics interface 47 of the housing 6, to the low-voltage module 38 in order to exchange signals with the control device 20 of the driving and recuperation axle 16.

The solution described is applicable to all trucks or tractors, regardless of whether they have a conventional drive, an electric drive or a fuel cell drive.

It is understood that the foregoing description is that of the preferred embodiments of the invention and that various changes and modifications may be made thereto without departing from the spirit and scope of the invention as defined in the appended claims.

### REFERENCE SIGNS

### Part of the Description

1 central electrical unit
2 semitrailer
3 mechanical interface
4 tractor
5 utility vehicle
6 housing
7 high-voltage network
8 low-voltage network
9 high-voltage battery
10 high-voltage distribution and protection unit
11 electrical cooler interface
12 battery charger
13 DC/DC converter
14 high-voltage interface for alternating current
15 low-voltage interface
16 electrically driven axle
17 mechanical axle
18 electric motor
19 inverter
20 control device of the electrically driven axle
21 wheel
22 cooling system
23 cooling line within the housing
24 electrical interface
25 cooling line within the housing
26 mating part of the high-voltage interface
27 mating part of the low-voltage interface
28 mating part of the cooling interface
29 high-voltage connection
30 low-voltage connection
31 cooling line
32 power interface
33 cooling unit of the semitrailer
34 interface of the battery charger
35 local voltage network
36 brake control device
37 telematics unit
38 low-voltage module
39 low-voltage distribution and protection unit
40 standardized interface between tractor and semitrailer
41 data and/or energy line
42 battery management system
43 control device interface
44 data and energy line
45 high-voltage line for alternating current
46 high-voltage interface for direct current
47 telematics interface

1. A central electrical device for operating an axle of a trailer or semitrailer of a utility vehicle, the axle being at least one of a recuperation axle and an electric drive axle, the central electrical device comprising:
a housing;
at least two components, wherein said at least two components are at least one of electrical components and electronic components; and,
said at least two components being in said housing and being interconnected inside said housing such that ones of said at least two components which operate at a same voltage level are routed to a common interface, formed on said housing, for connection to the axle of the trailer or semitrailer of the utility vehicle.

2. The central electrical device of claim 1, wherein the interconnection, within the housing, of said ones of said at least two components operating at the same voltage level is accomplished via a distribution unit corresponding to the same voltage level.

3. The central electrical device of claim 2, wherein said distribution unit has a protection unit.

4. The central electrical device of claim 1, wherein said electrical components of said at least two components operating at a high voltage level are connected via a high-voltage distribution and protection unit to a high-voltage source positioned in said housing and are routed to a common high-voltage interface for operating a drive component of the axle.

5. The central electrical device of claim 1, wherein said at least one of electrical components and electronic components are routed via a low-voltage module to a common low-voltage interface for controlling at least one low-voltage component positioned on the axle.

6. The central electrical device of claim 5, wherein said low-voltage module has a low-voltage distribution and protection unit.

7. The central electrical device of claim 5, wherein the low-voltage module is connected directly to a low-voltage source.

8. The central electrical device of claim 4, wherein said high-voltage interface, which is connected to the high-voltage source via an inverter, is configured as an alternating current interface for direct voltage supply to an electric motor driving the axle.

9. The central electrical device of claim 4, wherein said at least one of electrical components and electronic components are routed via a low-voltage module to a common low-voltage interface for controlling at least one low-voltage component positioned on the axle; wherein said high-voltage source is configured to supply voltage to an inverter positioned on at least one of the driving axle and the recuperation axle via said high-voltage interface configured as a direct current interface; and, said low-voltage interface is configured to supply and control a control device of the electric motor, the control device being mounted on the axle.

10. The central electrical device of claim 1 further comprising a cooling system for the axle arranged in said housing; and said cooling system being routed via a cooling line located within said housing to a coolant interface, formed on said housing, for cooling the axle.

11. The central electrical device of claim 5, wherein a control device outside said housing for the trailer or semitrailer, which is connected via a standardized interface between the tractor and the semitrailer to a data and energy line of the utility vehicle, is routed from outside via a control device interface of said housing to said low-voltage module and, via the low-voltage interface of said housing, outputs control signals to a control device of the axle.

12. The central electrical device of claim 11, wherein the control device outside the housing is a brake control device.

13. The central electrical device of claim 11, wherein the control device is connected to a telematics unit of the utility vehicle for improving at least one of driving dynamics, efficiency, and vehicle monitoring of the utility vehicle.

14. The central electrical device of claim 1 further comprising an electrical power interface configured to be routed via at least one power interface of said housing to an auxiliary unit of the trailer or semitrailer for the operation thereof; and, said electrical power interface is arranged in said housing.

15. The central electrical device of claim 14, wherein the auxiliary unit of the trailer or semitrailer is a cooling unit.

16. The central electrical device of claim 1 further comprising a battery charger connected to a further high-voltage interface of said housing for external energy transfer into and/or from a high-voltage battery in at least one direction; and, said battery charger is arranged in said housing.

17. The central electrical device of claim 1 further comprising a mechanical interface for fastening to a chassis of the trailer or semitrailer of the utility vehicle being formed on said housing.
